(19) United States
(12) Patent Application Publication
(10) Pub. No.: US 2017/0003137 A1
(43) Pub. Date: Jan. 5, 2017

(54) USER TRIP LIBRARIES

(71) Applicant: INRIX, Inc., Kirkland, WA (US)

(72) Inventor: Christopher L. Scofield, Seattle, WA (US)

(21) Appl. No.: 14/754,791

(22) Filed: Jun. 30, 2015

(51) Int. Cl. G01C 21/34; G06Q 30/02; G01C 21/36

(52) U.S. Cl. CPC G01C 21/3484; G01C 21/3423; G01C 21/3476; G01C 21/3617; G01C 21/3691; G06Q 30/0266

(57) ABSTRACT

One or more techniques and/or systems are provided for generating a trip library. Locational information, obtained from a device of a user (e.g., a mobile device, a wearable device, etc.), may be evaluated to identify trips traveled by the user and terminals traveled to by the user above a visitation frequency threshold (e.g., work, a favorite coffee shop, school, etc.). The trips and terminals may be evaluated to determined preferred trips that the user travels above a travel frequency threshold (e.g., routes that the user prefers to travel when going to a terminal, such as routine routes to a grocery store, work, etc.). A trip library, comprising the terminals, the preferred trips, and conditional likelihoods that he user will travel to a terminal given one or more conditions, may be created and used to preemptively provide the user with suggestions (e.g., notice of an event, coupon, alternative route, accident, etc.).

### BACKGROUND

Many devices, such as smart phones, vehicle navigation units, wearable devices, etc., may comprise communication and/or navigation functionality such as cellular communication and global positioning system (GPS) technology. In an example, a user may travel with such a device while in a vehicle. For example, the user may travel with a smart phone from home to a coffee shop, and then to work. On Monday through Thursday, the user may use a similar route to travel to the coffee shop and work. On Friday, the user may travel to a college to teach a class as an adjunct professor. In this way, the user may routinely travel to certain locations using similar routes. It may be advantageous to preemptively provide the user with relevant information associated with such locations and routes.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

Among other things, one or more systems and/or techniques for generating a trip library for a user are provided. In an example, locational information may be obtained from a device associated with a user (e.g., global positioning system (GPS) data, accelerometer data, gyroscope data, and/or other various locational data associated with a smart phone, a mobile device, a wearable device, a smart watch, smart glasses, a vehicle navigation unit, etc.). The locational information may be evaluated to identify a set of trips traveled by the user. For example, a set of locational points (e.g., GPS points indicative of an acceleration) may indicate that the user is transitioning from a walking mode of transportation to a vehicle mode of transportation, and a subsequent set of locations points may indicate that the user is transitioning from the vehicle mode of transportation to the walking mode of transportation. The change in modes of transportation may be indicative of a user traveling from a trip start location to a trip end location.

The locational information may be evaluated to identify a set of terminals traveled to by the user. For example, a location may be identified based upon a clustering of locational points indicative of a start trip location or an end trip location. The location may be identified as a terminal (e.g., a frequently or routinely visited location by the user) based upon a number of locational points of trips exceeding a visitation frequency threshold (e.g., a cluster of locational points may be identified as a terminal based upon the cluster comprising a threshold number of location points having a locational distribution within a spatially compact threshold).

The locational information may be evaluated to identify a set of preferred trips traveled by the user above a travel frequency threshold. For example, the user may routinely travel a similar route, comprising a neighborhood street, an expressway, and a city street, when traveling from a coffee shop to work.

In an example, the locational information may be evaluated to identify a set of conditional likelihoods indicative of the user traveling to destination terminals of the set of terminals based upon the set of preferred trips. For example, the set of conditional likelihoods may comprise a time of day condition, a day of week condition, a holiday condition, a school in session condition, an event occurrence condition, a weather condition, a user mood condition, etc. (e.g., a conditional likelihood that the user is going to travel to the coffee shop given that school is not in session, today is Monday, and today is the Fourth of July holiday). In an example, the set of conditional likelihoods may be used by a Bayes rule to compute a likelihood of the user visiting a terminal.

A trip library may be generated based upon the set of terminals and the set of preferred trips. In an example, the trip library may be generated based upon the set of conditional likelihoods. In an example, a suggestion may be provided to the user based upon the trip library. For example, the suggestion may preemptively notify that user (e.g., an alert triggered based upon a day of the week condition, a time condition, and/or other conditions indicative of the user having a relatively high likelihood of traveling to the coffee shop) that the routinely traveled route to the coffee shop has an accident, and that an alternative route could be used. The suggestion may comprise an advertisement, a coupon for the coffee shop, a point of interest along the routinely travel route and/or the alternative route (e.g., a grocery store that carries an item mentioned in a calendar entry shopping list of a user calendar of the user), an event (e.g., a festival occurring near the coffee shop), etc.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method of generating a trip library for a user.

FIG. 2 is a component block diagram illustrating an exemplary system for generating a trip library for a user, where a set of trips and a set of terminals are identified.

FIG. 3 is a component block diagram illustrating an exemplary system for generating a trip library for a user, where a set of preferred trips are identified.

FIG. 4 is a component block diagram illustrating an exemplary system for generating a trip library comprising a set of preferred trips, a set of terminals, and a set of conditional likelihoods.

FIG. 5 is a component block diagram illustrating an exemplary system for generating a trip library for a user, where a suggestion is provided to the user based upon the trip library.

FIG. 6 is a component block diagram illustrating an exemplary system for generating a trip library for a user, where a suggestion is provided to the user based upon the trip library.

FIG. 7 is a component block diagram illustrating an exemplary system for generating a trip library for a user, where a suggestion is provided to the user based upon the trip library.

FIG. 8 is an illustration of an exemplary computer readable medium wherein processor-executable instructions configured to embody one or more of the provisions set forth herein may be comprised.

FIG. 9 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth to provide an understanding of the claimed subject matter. It may be evident, however, that the claimed subject matter may be practiced without these specific details. In other instances, structures and devices are illustrated in block diagram form in order to facilitate describing the claimed subject matter.

One or more systems and/or techniques for generating a trip library for a user are provided. Locational information of a device associated with the user may be used to generate a trip library comprising terminals (e.g., routinely and/or frequently traveled to locations), preferred trips (e.g., routinely and/or frequently routes used to travel to terminals), and/or conditional likelihoods (e.g., a likelihood that the user will travel to a terminal given a particular time, day, and/or other conditions such as an occurrence of a holiday, school being in session, weather, user mood, an occurrence of an event, etc.). In this way, the trip library may be used to preemptively (e.g., before the user provides an indication, such as by requesting directions, that the user will travel to a location) provide the user with driving directions, alternative routes due to accidents or other reasons, notifications of events (e.g., a festival) or points of interest (e.g., an ice cream shop) along a route, coupons, advertisements, and/or a variety of other supplemental information and/or suggestions in response to the trip library indicating that current conditions (e.g., a current time of day, day of the week, weather, school being in or out of session, an occurrence of a holiday, etc.) are indicative of a threshold likelihood that the user will be traveling to a terminal.

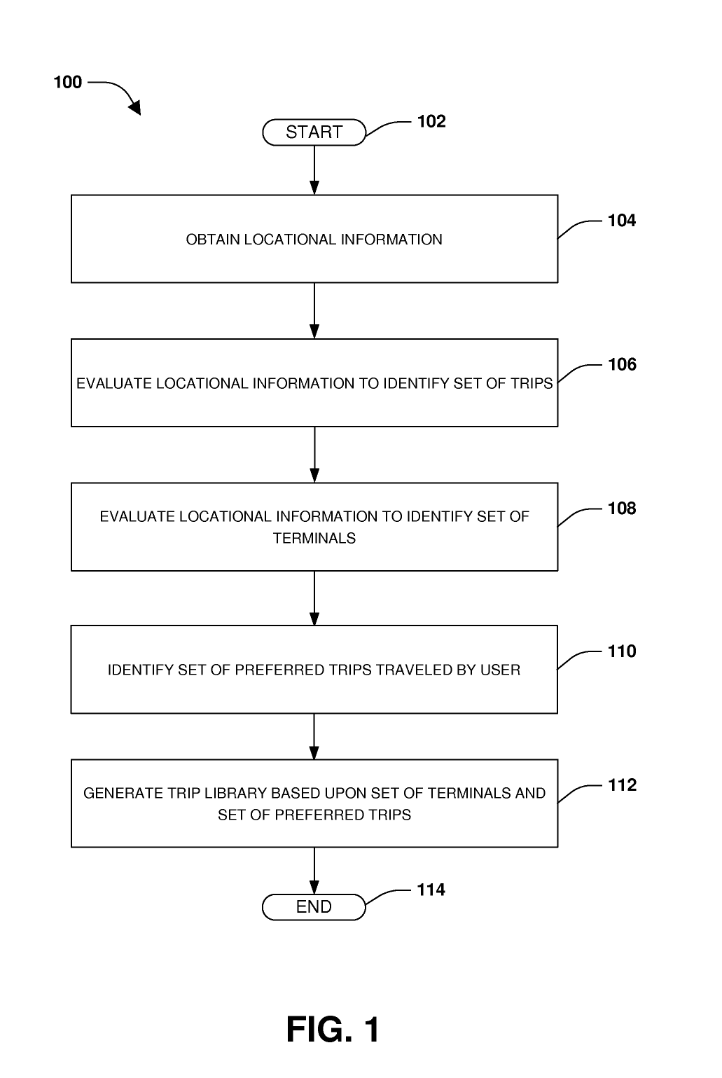

An embodiment of generating a trip library is illustrated by an exemplary method 100 of FIG. 1. At 102, the method 100 starts. At 104, locational information may be obtained from a device associated with a user. For example, the locational information may correspond to global positioning system (GPS) data, accelerometer data, gyroscope data, and/or other various locational data associated with a smart phone, a mobile device, a wearable device, a smart watch, smart glasses, a vehicle navigation unit, etc. At 106, the locational information may be evaluated to identify a set of trips traveled by the user. For example, the locational information may be evaluated to identify a first mode of transportation transition (e.g., a user walking to a car, and proceeding to drive the car) and a second mode of transportation transition (e.g., the user parking the car and walking into a soccer field). A trip start location of a trip may be identified based upon the first mode of transportation transition. A trip end location of the trip may be identified based upon the second mode of transportation transition. Various information, such as acceleration/deceleration measured by an accelerometer of the device, GPS data indicative of acceleration/deceleration, etc. may be used to identify the user changing between modes of transportation.

At 108, the locational information may be evaluated to identify a set of terminals traveled to by the user. For example, locational points, within the locational information, may be clustered to identify a cluster of location points that are indicative of a location corresponding to a trip start location or a trip end location. The cluster may be determined as being indicative of the location and/or a terminal based upon the cluster comprising a threshold number of locational points having a location distribution within a spatially compact threshold and/or a timespan threshold (e.g., the user may appear to stay at the location for a threshold amount of time that is indicative of the user visiting the location as opposed to driving past the location).

At 110, the set of trips and/or the set of terminals may be evaluated to identify a set of preferred trips traveled by the user above a travel frequency threshold. For example, a trip may be determined as a preferred trip based upon an occurrence of the trip between a first terminal (e.g., work) and a second terminal (e.g., the soccer field) exceeding a trip frequency threshold indicative of the user routinely and/or frequently taking a route of the trip between the terminals (e.g., a routinely traveled route by the user from work to the soccer field). In an example, a new trip may be determined as an occurrence of the trip based upon a set of location points of the new trip corresponding to a threshold number of locations points of the trip, and thus the new trip may be determined to be similar enough to the trip in order to be counted as an occurrence of the trip such as for purposes of incrementing a trip frequency count for comparison to the trip frequency threshold.

In an example, a set of conditional likelihoods, indicative of the user traveling to destination terminals of the set of terminals, may be determined based upon the set of preferred trips. In an example, a conditional likelihood may be computed by counting how often a result occurs given that a condition applies (e.g., a count of how often the user drives to a coffee shop given a current day of the week as Monday morning). A conditional likelihood may be determined as a probability that the user will travel to a destination given an occurrence of one or more route independent conditions. A route independent condition may comprise a time of day condition, a day of week condition, a holiday condition, a school in session condition, an event occurrence condition, a weather condition, a user mood condition (e.g., the user may indicate, such as through a social network post, that the user is excited about soccer practice), a user interest condition, a user social network post topic condition (e.g., the user may post a weekly soccer practice event reminder), a user calendar entry topic condition (e.g., a calendar entry for soccer practice), a message topic condition (e.g., an email about soccer practice), etc. In an example, a Bayes rule may be utilized to compute a likelihood of the user visiting a terminal based upon the set of conditional likelihoods. In an example, the conditional likelihood may be decomposed based upon a probability that a condition is a target condition given the user traveling to the destination (e.g., a probability that today is Friday given the user traveling to soccer practice), an overall probability of the user visiting the destination, and/or a modelization factor corresponding to a frequency of the user going to the destination compared to a sum of frequencies for visiting possible destinations.

At 112, a trip library may be generated to comprise the set of terminals and the set of preferred trips. In an example, the trip library may be generated to comprise the set of conditional likelihoods. In an example, metadata of a terminal may be stored within the trip library for the terminal. The metadata may comprise coordinates of the terminal, a mean time at which the terminal was entered or exited, a neighboring point of interest (e.g., a local park hosting a festival), a street address of the terminal, an event hosted at or within a threshold distance of the terminal (e.g., a local food truck event), a description of the terminal, etc. In an example, a preferred trip, within the trip library, may be identified as corresponding to a terminal. The user may be prompted to provide a description for the terminal (e.g., the user may specify a description or a description suggestion may be provided to the user for selection or modification). Responsive to receiving the description, the trip library may be updated with the description for the terminal.

In an example, the trip library may be used to preemptively provide recommendations, suggestions, and/or supplemental information to the user. For example, a condition may be identified (e.g., a non-rainy condition, a non-holiday condition, a Friday afternoon, a user social network post about soccer practice, etc.). The trip library may be evaluated based upon the condition to identify a preferred trip corresponding to the condition (e.g., the trip library may comprise a conditional likelihood of the user traveling a preferred travel route to a soccer field terminal after work based upon the condition of being non-rainy, a non-holiday, a Friday afternoon, and/or the occurrence of the social network post). In an example, supplemental content, corresponding to the preferred trip, may be identified. The supplemental content may comprise an advertisement associated with a destination terminal of the preferred trip or a nearby location (e.g., an advertisement of an ice cream shop within a threshold distance of the soccer field terminal, such as within 1.5 miles), weather information, travel time information, an incident along the preferred trip, an alternative route for the preferred trip, a website (e.g., a soccer training website), an image (e.g., a photo of an accident along a route of the preferred trip), a suggestion of a point of interest (e.g., a drinking water fountain), an event occurring at a location along the preferred trip or the alternative route (e.g., a band playing within a threshold distance of the soccer field), a recommendation (e.g., a reminder to bring suntan lotion), etc. The supplemental content may be provided to the user, such as through a mobile alert, an application user interface, a website, an email, a text message, etc. At 114, the method 100 ends.

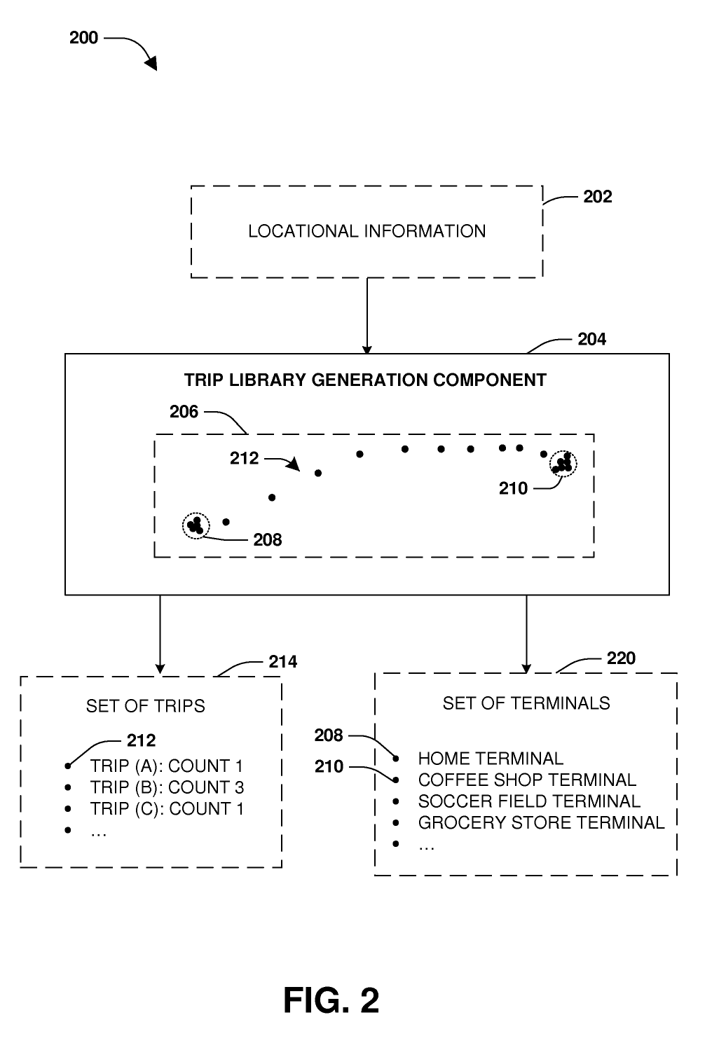

FIG. 2 illustrates an example of a system 200, comprising a trip library generation component 204, for identifying a set of trips 214 and/or a set of terminals 220. The trip library generation component 204 may obtain locational information 202, such as global positioning system (GPS) points from a mobile device of the user. The trip library generation component 204 may evaluate the locational information 202 to identify the set of trips 214 traveled by the user. For example, GPS points 206 may be indicative of a trip (A) 212 from a home terminal location 208, corresponding to a first cluster of GPS points, to a coffee shop terminal location 210 corresponding to a second cluster of GPS points. In this way, the set of trips 214 may be identified as comprising the trip (A) 212 having a count occurrence of 1, a trip (B) having a count occurrence of 3 (e.g., the user may have traveled the trip (B) 3 times within the last 20 days), a trip (C) having a count occurrence of 1, etc. The set of terminals 220 may comprise the home terminal location 208, the coffee shop terminal location 210, a soccer field terminal location, a grocery storage terminal location, and/or other locations identified from clusters of locational points.

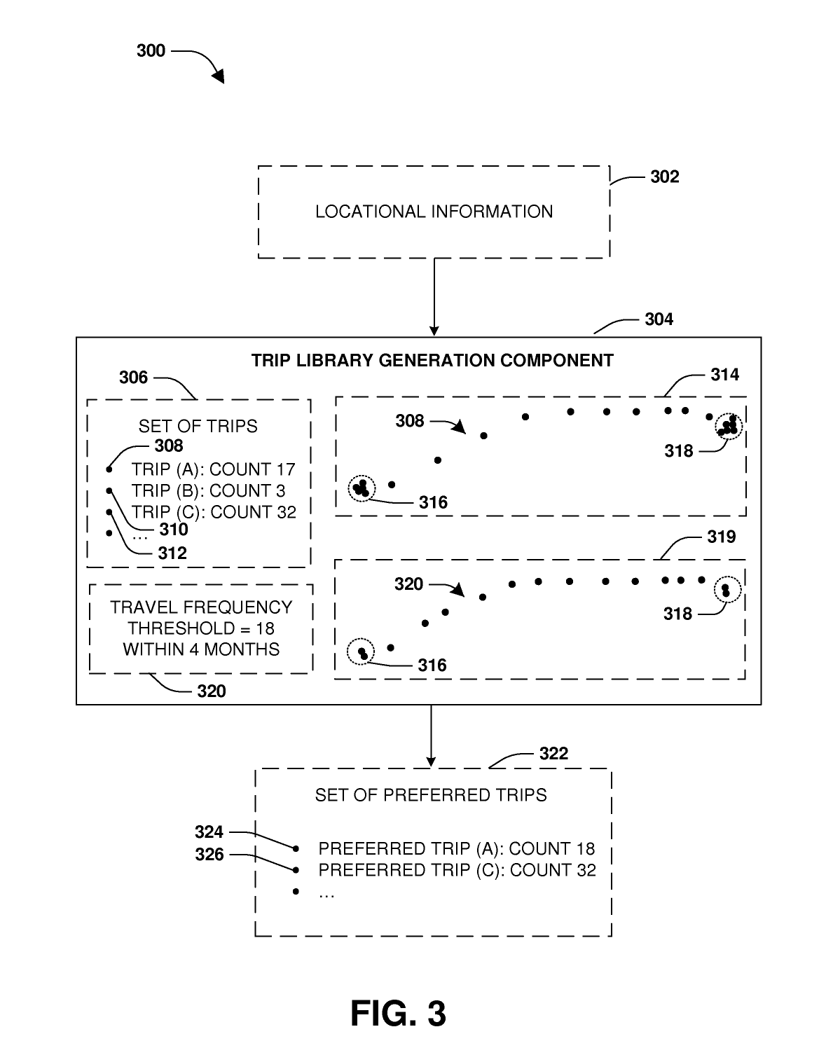

FIG. 3 illustrates an example of a system 300, comprising a trip library generation component 304, for identifying a set of preferred trips 322 of a user for inclusion within a trip library. The trip library generation component 304 may have identified a set of trips 306, traveled by the user, based upon locational information 302 of a device of the user. The trip library generation component 304 may update count occurrences of trips as the user travels similar routes of the trips. For example, the user may have traveled a trip (A) 308 17 times within the past month, a trip (B) 310 3 times within the past month, a trip (C) 312 32 times within the past month, etc. The trip library generation component 304 may increase an occurrence count based upon the user traveling a route similar to a previously traveled trip within the set of trips 306. For example, the trip library generation component 304 may determine that the location information 302 comprises a threshold number of locational points 319, of a trip 320, that are similar to locational points 314 of the trip (A) 308 from a home terminal 316 to a coffee shop terminal 318, and thus the trip library generation component 304 may increment an occurrence count for the trip (A) 308 from 17 to 18. The trip library generation component 304 may identify the set of preferred trips 322 as comprising trips from the set of trips 306 that exceed a travel frequency threshold 320 such as trips with occurrence counts equal to or greater than 18 occurrences within 4 months. In this way, the set of preferred trips 322 may comprise a preferred trip (A) 324 corresponding to the trip (A) 308, a preferred trip (B) 326 corresponding to the preferred trip (B) 310, etc.

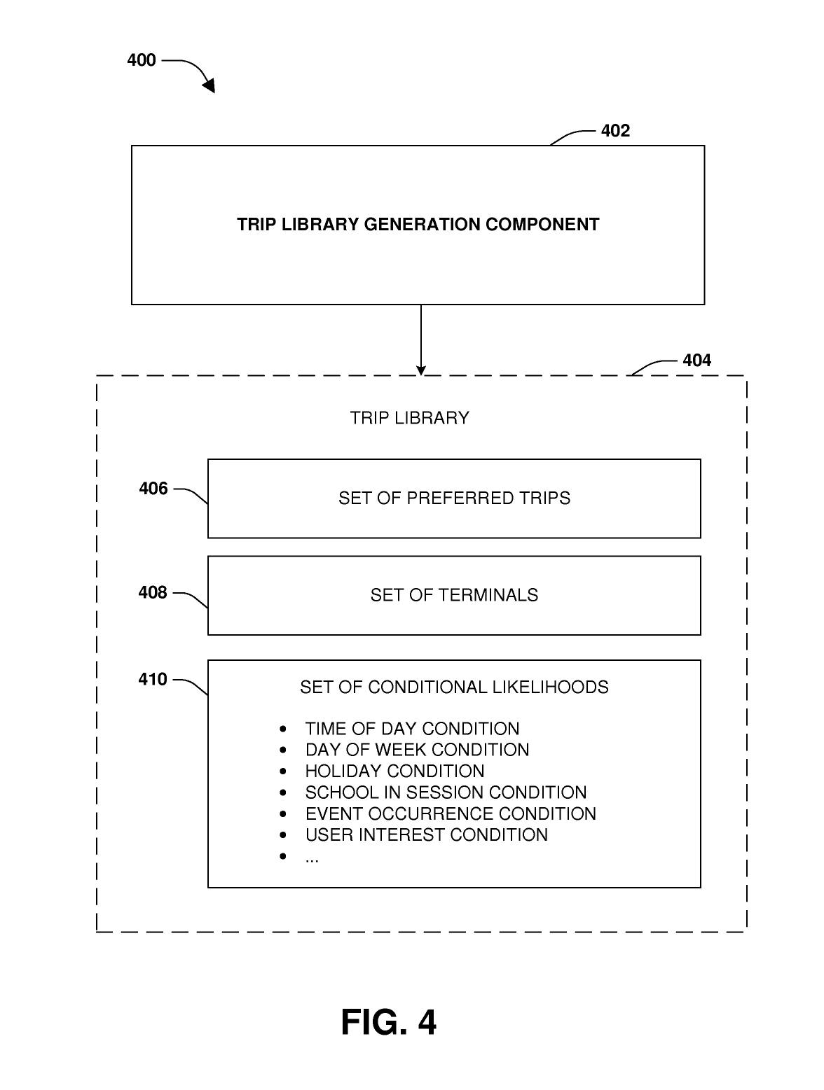

FIG. 4 illustrates an example of a system 400, comprising a trip library generation component 402, for generating a trip library 404. The trip library generation component 402 may have identified a set of preferred trips 406 (e.g., set of preferred trips 322 of FIG. 3) and a set of terminals 408 (e.g., set of terminals 220 of FIG. 2). The trip library generation component 402 may determine a set of conditional likelihoods 410 indicative of the user traveling to destination terminals of the set of terminals 408 based upon the set of preferred trips 406. The set of conditional likelihoods 410 may indicate a likelihood of the user traveling to a particular terminal based upon a particular time of day, day of the week, holiday, whether school is in session, an event occurring, the user having a particular interest, etc.

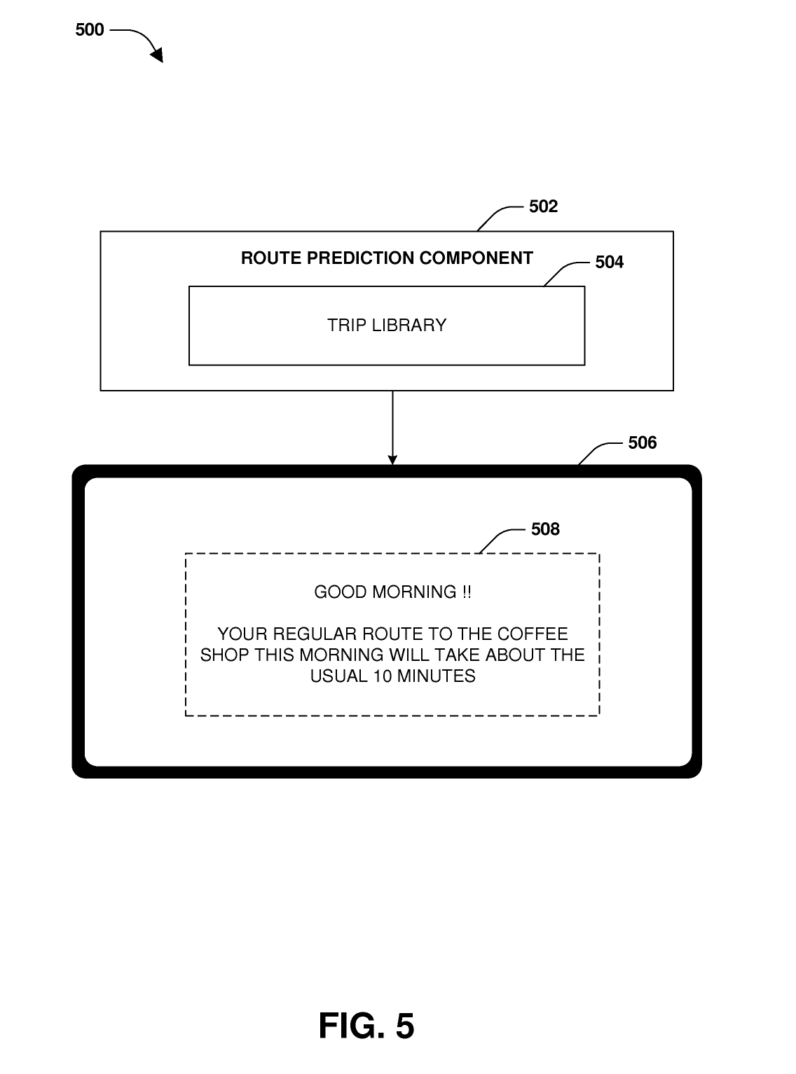

FIG. 5 illustrates an example of a system 500, comprising a route prediction component 502, configured to preemptively provide a user, through a user device 506, with information regarding a preferred trip that the user is predicted to take. The route prediction component 502 may identify a condition, such as a current time and day as Monday morning on a non-holiday. The route prediction component 502 may evaluate the trip library 504 using the condition to determine that there is a relatively high likelihood, given the condition of Monday morning on a non-holiday, that the user will leave home in an hour to travel to a coffee shop (e.g., a conditional likelihood within the trip library 504 may indicate the relatively high likelihood that the user will travel to a coffee shop terminal using a route of a preferred trip previously traveled by the user to the coffee shop terminal a threshold number of times). The route prediction component 502 may display a suggestion interface 508 (e.g., an email, a text message, a mobile alert, a social network message, a website, an audio message alert, a video, etc.) with a suggestion that the user's regular route will take about 10 minutes longer than usual to get to the coffee shop. In this way, the user may be preemptively notified (e.g., before requesting directions to the coffee shop) about various information regarding traveling to a terminal to which the user is predicted to likely travel.

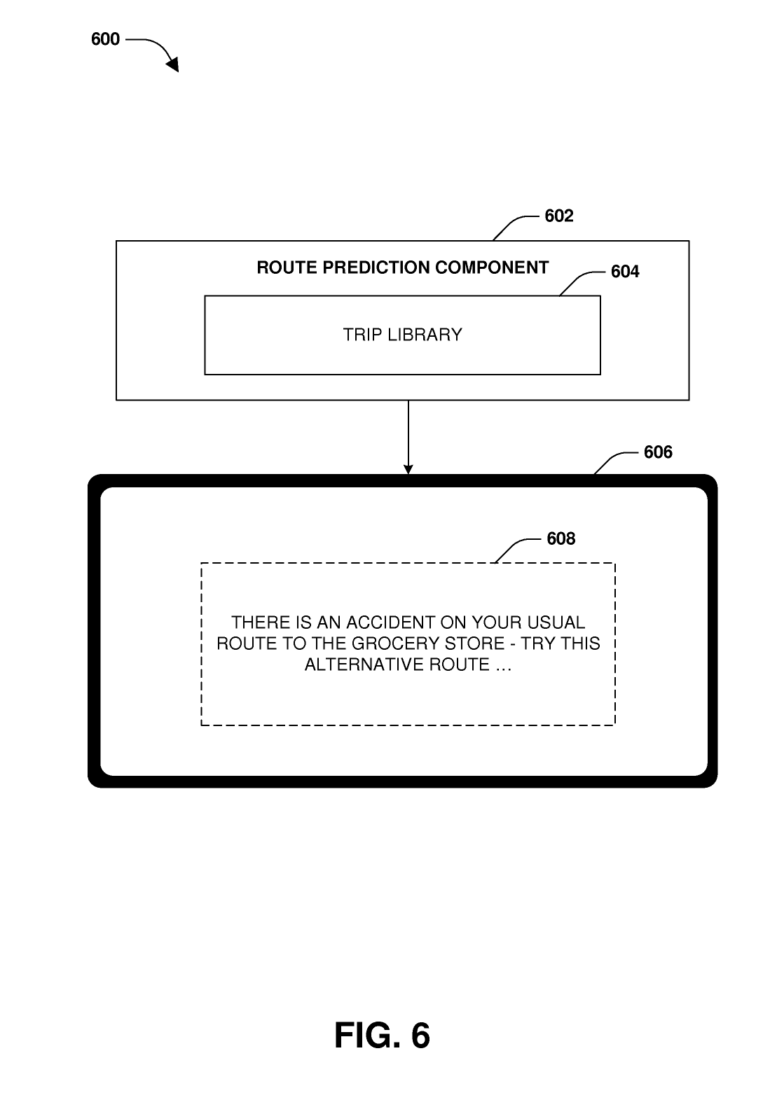

FIG. 6 illustrates an example of a system 600, comprising a route prediction component 602, configured to preemptively provide a user, through a user device 606, with information regarding a preferred trip that the user is predicted to take. The route prediction component 602 may identify a condition, such as a calendar entry (e.g., grocery shopping today), a current day as Sunday, and/or other information (e.g., a smart refrigerator may provide an indication that the user is low on various foods). The route prediction component 602 may evaluate the trip library 604 using the condition to determine that there is a relatively high likelihood, given the condition of the calendar entry, the day being Sunday, and the smart refrigerator notification, that the user will leave home in about 2 hours to travel to a grocery store (e.g., a conditional likelihood within the trip library 604 may indicate the relatively high likelihood that the user will travel to a grocery store terminal using a route of a preferred trip previously traveled by the user to the grocery store terminal a threshold number of times). The route prediction component 602 may display a suggestion interface 608 (e.g., an email, a text message, a mobile alert, a social network message, a website, an audio message alert, a video, etc.) with a suggestion that the user's regular route has an accident. The suggestion interface 608 may be populated with an alternative route for the user to travel to the grocery store (e.g., the user may use the suggestion to launch a map interface on the user device 606 that is populated with the alternative route). In this way, the user may be preemptively notified (e.g., before requesting directions to the grocery store) about various information regarding traveling to a terminal to which the user is predicted to likely travel.

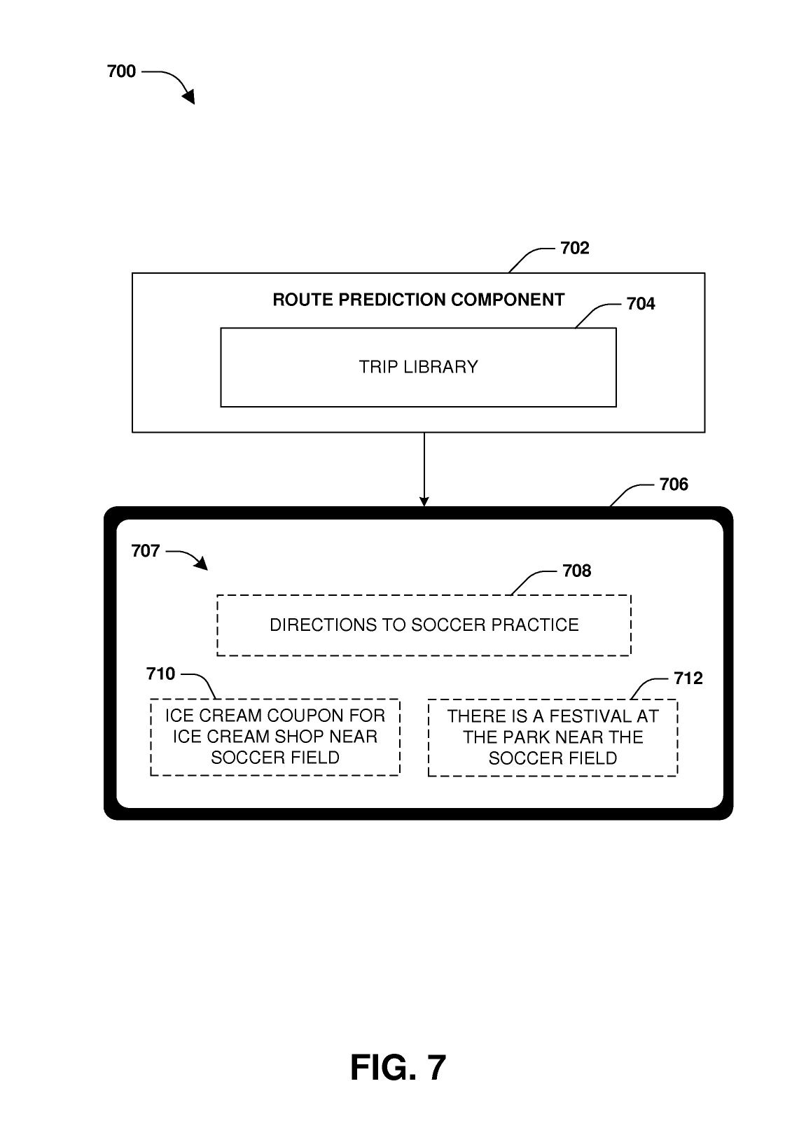

FIG. 7 illustrates an example of a system 700, comprising a route prediction component 702, configured to preemptively provide a user, through a user device 707, with information regarding a preferred trip that the user is predicted to take. The route prediction component 702 may identify a condition, such as a current time and day as Tuesdays at 3:30 with 75 degree sunny weather. The route prediction component 702 may evaluate the trip library 704 using the condition to determine that there is a relatively high likelihood, given the condition of a sunny Tuesday afternoon, that the user will leave work in 2 hours to travel to a soccer field (e.g., a conditional likelihood within the trip library 704 may indicate the relatively high likelihood that the user will travel to a soccer field terminal using a route of a preferred trip previously traveled by the user to the soccer field terminal a threshold number of times). The route prediction component 702 may display a suggestion interface 707 (e.g., an email, a text message, a mobile alert, a social network message, a website, an audio message alert, a video, etc.) populated with directions to soccer practice 708, a coupon 710 for an ice cream shop near the soccer field, an event notification 712 of a festival near the soccer field, and/or other supplemental content (e.g., a user interface used to message teammates about practice such as by sending an email or group text message). In this way, the user may be preemptively notified (e.g., before requesting directions to the soccer field) about various information regarding traveling to a terminal to which the user is predicted to likely travel.

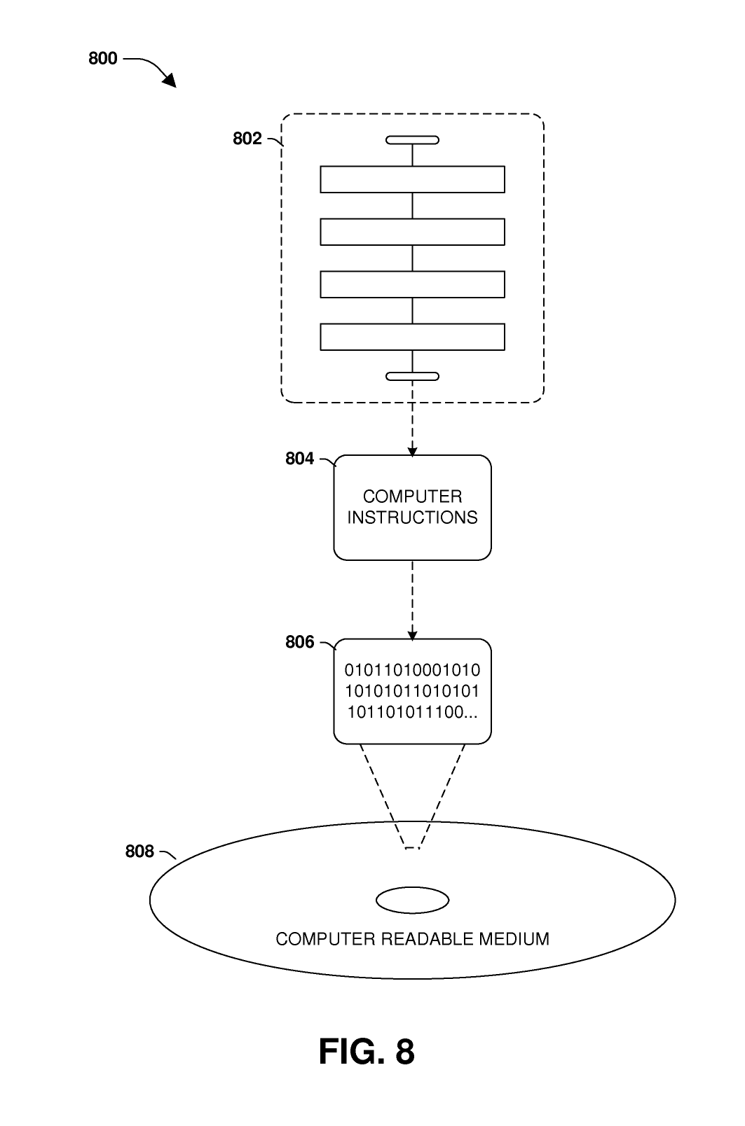

Still another embodiment involves a computer-readable medium comprising processor-executable instructions configured to implement one or more of the techniques presented herein. An example embodiment of a computer-readable medium or a computer-readable device is illustrated in FIG. 8, wherein the implementation 800 comprises a computer-readable medium 808, such as a CD-ft DVD-R, flash drive, a platter of a hard disk drive, etc., on which is encoded computer-readable data 806. This computer-readable data 806, such as binary data comprising at least one of a zero or a one, in turn comprises a set of computer instructions 804 configured to operate according to one or more of the principles set forth herein. In some embodiments, the set of computer instructions 804 are configured to perform a method 802, such as at least some of the exemplary method 100 of FIG. 1, for example. In some embodiments, the set of computer instructions 804 are configured to implement a system, such as at least some of the exemplary system 200 of FIG. 2, at least some of the exemplary system 300 of FIG. 3, at least some of the exemplary system 400 of FIG. 4, at least some of the exemplary system 500 of FIG. 5, at least some of the exemplary system 600 of FIG. 6, and/or at least some of the exemplary system 700 of FIG. 7, for example. Many such computer-readable media are devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

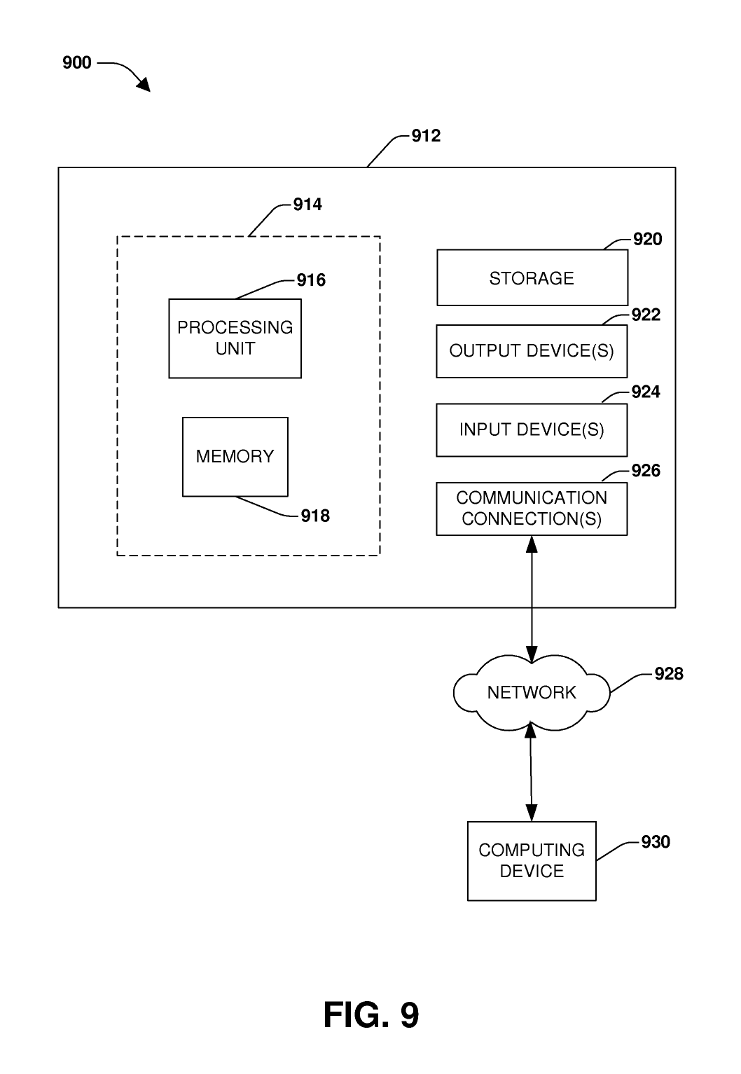

FIG. 9 and the following discussion provide a brief, general description of a suitable computing environment to implement embodiments of one or more of the provisions set forth herein. The operating environment of FIG. 9 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 9 illustrates an example of a system 900 comprising a computing device 912 configured to implement one or more embodiments provided herein. In one configuration, computing device 912 includes at least one processing unit 916 and memory 918. Depending on the exact configuration and type of computing device, memory 918 may be volatile (such as RAM, for example), non-volatile (such as ROM, flash memory, etc., for example) or some combination of the two. This configuration is illustrated in FIG. 9 by dashed line 914.

In other embodiments, device 912 may include additional features and/or functionality. For example, device 912 may also include additional storage (e.g., removable and/or non-removable) including, but not limited to, magnetic storage, optical storage, and the like. Such additional storage is illustrated in FIG. 9 by storage 920. In one embodiment, computer readable instructions to implement one or more embodiments provided herein may be in storage 920. Storage 920 may also store other computer readable instructions to implement an operating system, an application program, and the like. Computer readable instructions may be loaded in memory 918 for execution by processing unit 916, for example.

The term “computer readable media” as used herein includes computer storage media. Computer storage media includes volatile and nonvolatile, removable and non-removable media implemented in any method or technology for storage of information such as computer readable instructions or other data. Memory 918 and storage 920 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 912. Computer storage media does not, however, include propagated signals. Rather, computer storage media excludes propagated signals. Any such computer storage media may be part of device 912.

Device 912 may also include communication connection(s) 926 that allows device 912 to communicate with other devices. Communication connection(s) 926 may include, but is not limited to, a modem, a Network Interface Card (NIC), an integrated network interface, a radio frequency transmitter/receiver, an infrared port, a USB connection, or other interfaces for connecting computing device 912 to other computing devices. Communication connection(s) 926 may include a wired connection or a wireless connection. Communication connection(s) 926 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 912 may include input device(s) 924 such as keyboard, mouse, pen, voice input device, touch input device, infrared cameras, video input devices, and/or any other input device. Output device(s) 922 such as one or more displays, speakers, printers, and/or any other output device may also be included in device 912. Input device(s) 924 and output device(s) 922 may be connected to device 912 via a wired connection, wireless connection, or any combination thereof. In one embodiment, an input device or an output device from another computing device may be used as input device(s) 924 or output device(s) 922 for computing device 912.

Components of computing device 912 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 912 may be interconnected by a network. For example, memory 918 may be comprised of multiple physical memory units located in different physical locations interconnected by a network.

Those skilled in the art will realize that storage devices utilized to store computer readable instructions may be distributed across a network. For example, a computing device 930 accessible via a network 928 may store computer readable instructions to implement one or more embodiments provided herein. Computing device 912 may access computing device 930 and download a part or all of the computer readable instructions for execution. Alternatively, computing device 912 may download pieces of the computer readable instructions, as needed, or some instructions may be executed at computing device 912 and some at computing device 930.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B and/or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method for generating a trip library for a user, comprising:
obtaining locational information from a device associated with a user;
evaluating the locational information to identify a set of trips traveled by the user;
evaluating the locational information to identify a set of terminals traveled to by the user;
evaluating the set of trips and the set of terminals to identify a set of preferred trips traveled by the user above a travel frequency threshold; and
generating a trip library based upon the set of terminals and the set of preferred trips.

2. The method of claim 1, the evaluating the locational information to identify a set of trips comprising:
evaluating the locational information to identify a first mode of transportation transition and a second mode of transportation transition;
identifying a trip start location of a trip based upon the first mode of transportation transition; and
identifying a trip end location of the trip based upon the second mode of transportation transition.

3. The method of claim 2, the evaluating the locational information to identify a first mode of transportation transition comprising:
identifying a change in velocity indicative of the user changing from a first mode of transportation to a second mode of transportation.

4. The method of claim 1, the evaluating the locational information to identify a set of terminals comprising:
clustering locational points within the locational information to identify a cluster indicative of a location corresponding to at least one of a trip start location or a trip end location; and
determining that the cluster is indicative of a terminal based upon the cluster comprising a threshold number of locational points having a locational distribution within a spatially compact threshold.

5. The method of claim 1, comprising:
determining a set of conditional likelihoods, for inclusion within the trip library, indicative of the user traveling to destination terminals of the set of terminals based upon the set of preferred trips.

6. The method of claim 1, the generating a trip library comprising:
storing, within the trip library for a terminal within the set of terminals, at least one of coordinates of the terminal, a mean time at which the terminal was entered or exited, a neighboring point of interest within a threshold distance of the terminal, a street address of the terminal, an event hosted at the terminal, or a description of the terminal.

7. The method of claim 1, the evaluating the set of trips and the set of terminals to identify a set of preferred trips comprising:
responsive to identify an occurrence of a trip between a first terminal and a second terminal exceeding a trip frequency threshold, determining that the trip is a preferred trip.

8. The method of claim 7, the determining that the trip is a preferred trip comprising:
determining that a first trip is an occurrence of the trip based upon a set of location points of the first trip corresponding to a threshold number of locational points of the trip.

9. The method of claim 5, the determining a set of conditional likelihoods comprising:
determining a first conditional likelihood as a probability that the user will travel to a destination given an occurrence of one or more route independent conditions.

10. The method of claim 9, a route independent condition comprising at least one of a time of day condition, a day of week condition, a holiday condition, a school in session condition, an event occurrence condition, a weather condition, a user mood condition, a user interest condition, a user social network post topic condition, a calendar entry topic condition, or a message topic condition.

11. The method of claim 9, the determining a first conditional likelihood comprising:
decomposing the first conditional likelihood based upon a probability that a condition is a target condition given the user traveling to the destination, an overall probability of the user visiting the destination, and a modelization factor corresponding to a frequency of going to the destination compared to a sum of frequencies for visiting possible destinations.

12. The method of claim 5, comprising:
utilizing a Bayes rule to compute a likelihood of the user visiting a terminal based upon the set of conditional likelihoods.

13. The method of claim 1, comprising:
identifying a preferred trip, within the trip library, corresponding to a terminal;
prompting the user to provide a description for the terminal; and
responsive to receiving the description, updating the trip library based upon the description.

14. The method of claim 1, comprising:
identifying a condition;
evaluating the trip library based upon the condition to identify a preferred trip; and
providing a recommendation associated with the preferred trip to the user.

15. The method of claim 14, comprising:
identifying supplement content corresponding to the preferred trip; and
providing the supplemental content to the user.

16. The method of claim 15, the supplemental content comprising at least one of an advertisement associated with a destination terminal of the preferred trip, weather information, travel time information, an incident along the preferred trip, an alternative route, a website, an image, a suggestion of a point of interest, or an event occurring at a location along the preferred trip.

17. A system for generating a trip library for a user, comprising:
a trip library generation component configured to:
obtain locational information from a device associated with a user;
evaluate the locational information to identify a set of trips traveled by the user;
evaluate the locational information to identify a set of terminals traveled to by the user;
evaluate the set of trips and the set of terminals to identify a set of preferred trips traveled by the user above a travel frequency threshold; and
generate a trip library based upon the set of terminals and the set of preferred trips; and
a route prediction component configured to:
identify a condition;
evaluate the trip library based upon the condition to identify a preferred trip; and
provide a recommendation associated with the preferred trip to the user.

18. The system of claim 17, the trip library generation component configured to:
determine a set of conditional likelihoods, for inclusion within the trip library, indicative of the user traveling to destination terminals of the set of terminals based upon the set of preferred trips.

19. The system of claim 17, the route prediction component configured to:
identify supplement content corresponding to the preferred trip, the supplemental content comprising at least one of an advertisement associated with a destination terminal of the preferred trip, weather information, travel time information, an incident along the preferred trip, an alternative route, a website, an image, a suggestion of a point of interest, or an event occurring at a location along the preferred trip; and
provide the supplemental content to the user.

20. A computer readable medium comprising instructions which when executed perform a method for generating a trip library for a user, comprising:
obtaining locational information from a device associated with a user;
evaluating the locational information to identify a set of trips traveled by the user;
evaluating the locational information to identify a set of terminals traveled to by the user;
evaluating the set of trips and the set of terminals to identify a set of preferred trips traveled by the user above a travel frequency threshold;
determining a set of conditional likelihoods indicative of the user traveling to destination terminals of the set of terminals based upon the set of preferred trips;
generating a trip library based upon the set of terminals, the set of preferred trips, and the set of conditional likelihoods;
identifying a condition;
evaluating the trip library based upon the condition to identify a preferred trip; and
providing a recommendation associated with the preferred trip to the user.
